(19) United States
(12) Patent Application Publication
(10) Pub. No.: US 2006/0103075 A1
(43) Pub. Date: May 18, 2006

(54) Triple lip fork seal

(76) Inventor: Henry W. Zahn, Tulsa, OK (US)

Correspondence Address: HEAD, JOHNSON & KACHIGIAN, 228 W 17TH PLACE, TULSA, OK, 74119, US

(21) Appl. No.: 10/990,183

(22) Filed: Nov. 15, 2004

(51) Int. Cl. B60T 11/236

(52) U.S. Cl. 277/436; 277/562

(57) ABSTRACT

A triple lip seal for reciprocating members, and especially for an inner cylindrical tube connected to a vehicle wheel and an off-road motorcycle or bicycle. The seal includes an oil side beam generally parallel to the axis of the reciprocating members and having at least two sealing lips for engaging the inner cylindrical tube and wherein the forces applied to the seal are balanced between the two lips to resist flattening of the sealing lips against the shaft and to enhance the service life of the seal. The seal also includes an air side beam having a third sealing lip engaging the inner cylindrical tube.

### BACKGROUND OF THE INVENTION

1. Field of the Invention.

The present invention relates to seals for a set of reciprocating parts, and more particularly, to seals for shock absorbers which absorb mechanical vibration from road impacts comprising a front wheel suspension of recreational vehicles, such as motorcycles, bicycles and the like.

2. Prior Art.

Motorcycles and many bicycles, especially off-road cycles or bikes, have front wheel suspension fork assemblies which include a pair of spaced parallel shock absorbers. Each shock absorber typically comprises an inner tube or shaft connected to the axle of the front wheel and a co-axial, oil-filled outer tube or cylinder connected to the frame of the vehicle and within which the shaft is reciprocable to absorb shocks imparted to the front wheel. Two or more seals are required between the shaft and cylinder for preventing leakage of oil from the cylinder and for preventing entry of air, moisture, dust and dirt into the cylinder. U.S. Pat. No. 6,568,664 to Furuya and U.S. Patent Application Publication U.S. 2003/0019692 A1 to Downes et al. disclose representative examples of prior art seals.

In off-road cycling and, in particular, motor-cross races and competitions, the cycles are driven over a series of jumps and other hazards causing the cycle and rider to become air borne and to return to earth with a tremendous impact. The repetition of these impacts imposes large stresses on the shock absorber seals causing the seals to rapidly deteriorate, diminishing seal performance in sealing between the shaft and cylinder, and in some cases causing the seal to mechanically fail. Also the pressure on the lip or lips can become so great as to wipe the sealing surfaces free of lubrication. Without lubrication, the wear rate increases and the lips become distorted, resulting in premature seal failure.

Additionally, these competitions and other uses involve off-road driving in dusty and dirty conditions.

Accordingly, an object of the invention is to provide an oil seal for a pair of reciprocatory members, especially the reciprocable shaft or cylinder of a motorcycle or like shock absorber that will have a long and effective service life.

### SUMMARY OF THE INVENTION

In accordance with the invention, an oil seal for a shock absorber is comprised of multiple sealing lips. The seal has an oil side and an air side. The oil side of the seal comprises at least two axially spaced sealing lips for sealingly engaging a shock absorber shaft. The seal further comprises a supporting structure for the lips that causes frictional forces imparted to the shock absorber seal to be balanced, i.e., to be approximately evenly distributed, between the two oil-side sealing lips.

The supporting structure includes a body or mounting portion to be secured to the shock absorber cylinder having a casing defining a fixed point for the seal and an oil side beam extending from the fixed point in a direction generally parallel to, i.e., co-axial with, the shaft and the two axially spaced sealing lips. An annular spring biases the beam toward the shaft. The two lips have an interference fit with the shaft and the beam has a narrowed neck between the two lips, which facilitates a separate flex point for each lip. The oil side beam is exposed to the oil and thus the hydraulic pressure within the cylinder.

The beam and lip geometry, the beam length, the narrowed neck between the lips, the location and tension of the spring, and the hydraulic pressures are correlated to cause the extreme loads imposed upon the seal, and particularly the friction loads imposed on the two oil side lips, to be balanced between the lips. Because the loads are balanced, there is a significant reduction in the tendency of one of the lips and the beam to flatten out against the shaft, thereby enhancing seal performance and service life.

In a preferred embodiment, the sealing lips are provided with a low friction, hard material for engagement with the shaft to reduce the drag force against and along the shaft and with the balanced lip geometry in preventing uneven distortion to the inner lips as high cavity pressure would flatten the lip against the shaft, eliminate the lubricant film. An all rubber lip would grab and tend to follow the shaft tearing the lip. Most preferably, the lips are comprised of a low friction, hard and durable elastomer.

In the preferred embodiment, the oil seal is comprised of three sealing lips all shaped and arranged to seal in one direction. The air side of the seal has a garter spring lip properly positioned to rotate the lip contact point toward the oil side and thereby providing a triple lip sealing arrangement with one lip excluded from the cavity pressure extreme and function as an oil seal. This sealing lip is also preferably comprised of a low friction elastomer.

The invention thus provides a greatly improved oil seal capable of withstanding the repetitious and extreme impact loads imposed on the shock absorbers comprising the front wheel forks of cycles, and providing a long seal service life.

These and other objects and advantages of the invention will become apparent to those of reasonable skill in the art from the following detailed description, as considered in conjunction with the accompanying drawings.

### BRIEF DESCRIPTION OF THE DRAWINGS

FIG. 1 is a cross sectional view of the triple lip seal constructed in accordance with the present invention shown with an inner cylindrical tube and an existing dust excluder seal;

FIG. 2 is a cross-sectional view of the seal of FIG. 1;

FIG. 3 is an enlarged view of a portion of the seal shown in FIG. 2; and

FIG. 4 is a perspective view of the seal shown in FIG. 1 apart from the inner cylindrical tube.

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

The following is a detailed description of an embodiment of the invention presently contemplated by the inventor to be the best mode of carrying out his invention.

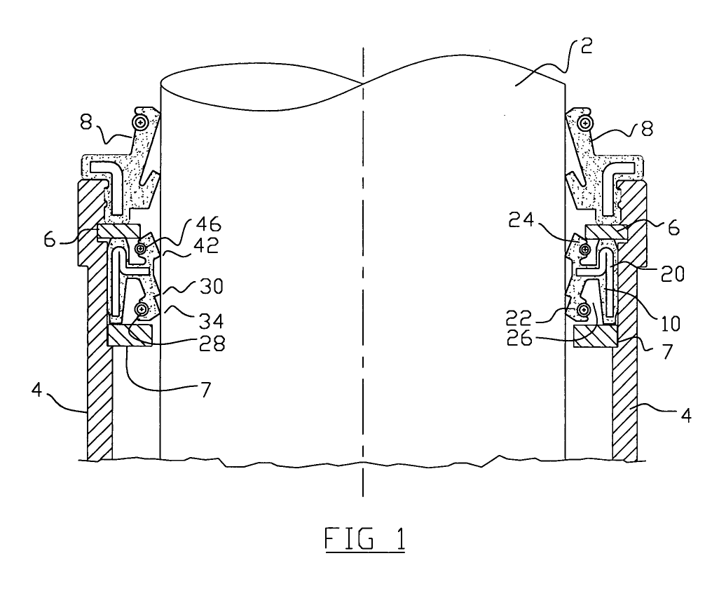

FIG. 1 illustrates a portion of an inner cylinder shaft or tube 2 which moves with respect to an outer cylindrical tube 4 (seen in cross-section in FIG. 1). An oil seal 10 of the present invention is juxtaposed between the inner cylindrical tube 2 and outer tube 4 and retained between a spring keeper retaining ring 6 and a washer 7 which rests on an interior shoulder in the outer tube 4.

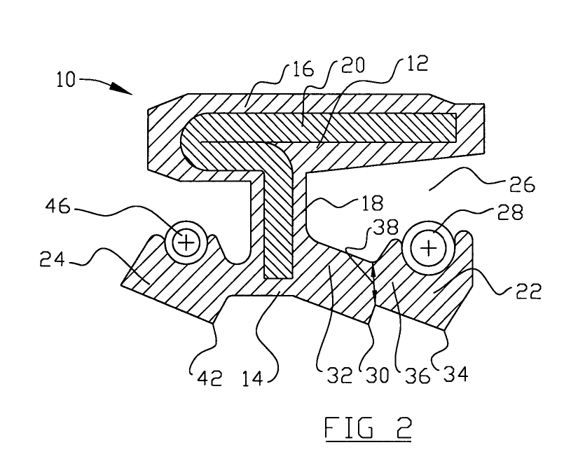

FIG. 2 is a cross-sectional view of an oil seal 10 which is comprised of a body or mounting portion indicated generally at 12 and a sealing portion indicated generally at 14. The body 12 rests against the outer tube 4 and is held in place by the spring keeper retaining ring 6 and washer 7.

The body or mounting portion 12 comprises an annular ring 16 adapted to be secured to one of a pair of reciprocating parts or members. The annular ring 16 and a radially extending annular web 18 are reinforced by a metal insert or casing 20 which is relatively rigid.

The casing 20 defines a fixed point from which a pair of annular beams 22 and 24 extend in opposite directions. The beams 22 and 24 extend in directions generally parallel to, i.e., coaxial with the reciprocating members, specifically the inner cylindrical tube 2 of the shock absorber. The beam 22 extends into an oil side of a shock absorber cylinder and the beam 24 extends to an air side. The oil seal 10 of the invention is used in combination with a conventional shock absorber dust excluder seal 8, which are known in the art. The dust seal 8 is axially spaced from the air side of the seal 10. The dust seal 8 functions to exclude dust, dirt and other foreign matter from the oil seal to preserve the life of the seal.

The oil side beam 22 extends in spaced, generally parallel relation to the annular ring 16 so that an annular chamber 26 is formed between the annular ring 16, web 18 and beam 22 which is adapted to be filled with oil or hydraulic fluid so that the pressure of the hydraulic fluid will force the beam 22 toward the reciprocating shaft 2. An annular coil spring 28 encircles the beam 22 adjacent its free end and also biases the beam 22 against the shaft 2.

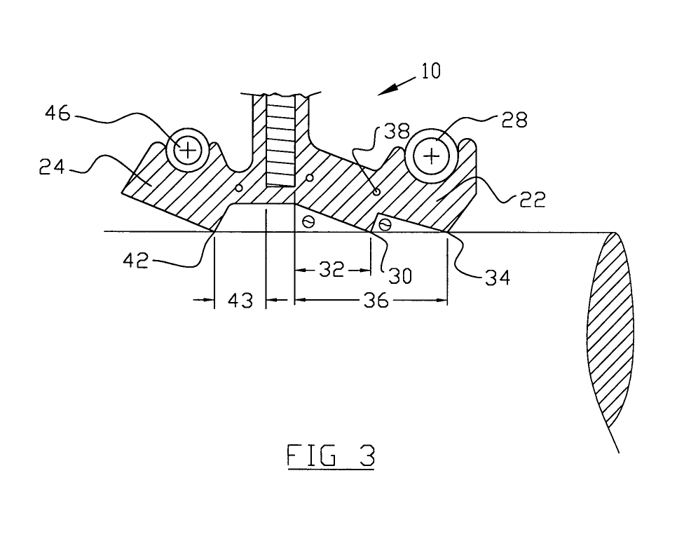

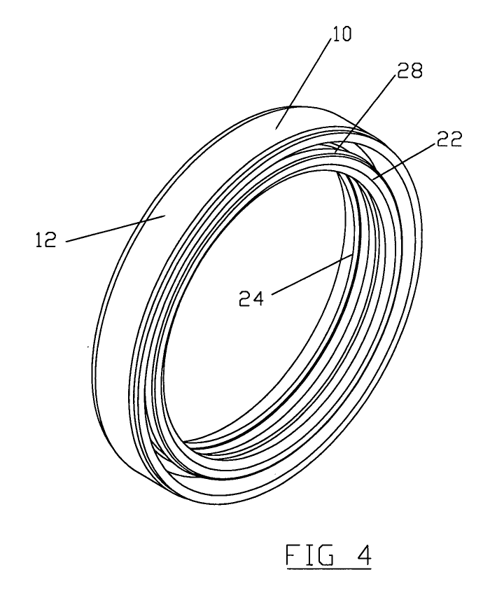

FIG. 3 illustrates an enlarged view of a portion of the seal 10 while FIG. 4 illustrates a perspective view of the device. On a shaft engaging side, the oil side beam 22 is configured to provide two axially spaced sealing lips, namely, a first elastomeric sealing lip 30 spaced a first distance or beam length illustrated by arrows 32 from a relatively fixed point defined by the metal insert or casing 20 and a second lip 34 spaced a second and greater distance or beam length illustrated by arrows 36 from the metal insert or casing. Both lips are designed to have an interference fit with the reciprocating shaft, i.e., each lip at rest before installation has an inner diameter less than the outer diameter of the shaft. When the seal is assembled on the shaft, this interference fit produces a hoop force on the sealing lips in addition to the hydraulic pressure and spring forces.

In the space between the lips 30 and 34, preferably contiguous to the oil side of lip 30, the beam 22 has a narrowed neck illustrated by arrows 38 in FIG. 2 which facilitates independent action of the two lips 30 and 34.

The oil side sealing lips 30 and 34 are preferably comprised of low friction nitrite rubber containing low friction additives such as PTFE, MOS2, Teflon® flake material, to minimize friction drag, improve structurally stability of the beam, and enhance the sealing capability of the lips. The geometry of the lips and the proximity between the metal case and the sealing lip contact area results in the two lips exerting equal lip force against the sealing surface. Furthermore, the angle (O) to the shaft seen in FIG. 3 reduces the tendency of the lips and beam to flatten out against the shaft when subjected to high pressure loads.

The air side beam 24 is configured to define a third sealing lip 42 having a beam length from the metal insert illustrated by arrows 43. The air side lip 42, like the lip 34, has an interference fit with the shaft and has a geometry that allows this unique lip to act as the third sealing lip.

Furthermore, this lip is not distorted by internal cavity pressure and therefore has better oil sealing function. It functions independently as an oil retaining wiper lip. An annular coil spring 46 surrounds the beam 24 and biases the lip 42 against the shaft to retain the lubricating fluid.

The third sealing lip 42 acts as a scraper and becomes a third sealing member. The third sealing lip 42 is outside of the pressure cavity and is not distorted by impulse pressure of the reciprocating members.

The standard existing sealing lips to date have a coefficient of friction range of about 0.20˜0.30 while the sealing lips of the present invention has a coefficient of friction range of about 0.15˜0.18. The low friction self-lubricating material reduces friction loading on the seal lips and provide for smooth shaft movement without lip wrap and without seizing or grabbing of the sealing lips on the shaft.

To impart a long and effective life to the seal 10 and to help restrict flattening of the beams against the sealing surfaces, the drag forces should be reasonably balanced over the two oil side sealing lips and the lip forces that vary through a range of pressure maintain a narrow difference between the resultant drag impacting on the seal. In particular, the frictional forces impacting on the oil side of the seal when subjected to a wide range of cavity pressure should be closely balanced, i.e., substantially equally distributed, between the sealing lips 30 and 34. The total load applied to each of the lips includes forces due to rubber hoop forces (F_{R}), beam deflection (F_{B}), spring tension (F_{S}) and cavity pressure (Fₚ). Hoop forces result from the expansion of the seal when it is installed on a shaft, as the inner diameter of the seal lip is typically smaller than the shaft. Beam deflection forces result from the bending moment of the beam, and depend on the beam flex thickness (t), the distance between the lip contact point and the flex point of the beam (L) and the modulus of elasticity of the beam (Ea). Spring tension is a radial force applied by the annular spring 28 and depends on spring deflection (F) and the axial distance between the center of the spring and the lip contact point measured axially (Rᵣ). The frictional force is the total lip force times the coefficient of friction for each lip, respectively. Benefits of the invention are realized when the forces due to rubbing friction are distributed equally plus or minus 15% between the oil side lips through the entire range of cavity pressure differences. Preferably the lip forces are distributed where the greater load is on the second lip 34 through the wide cavity pressure range to balance drag forces through out these ranges and extend the seal life.

The total radial force (F_{T}) applied to each lip is determined by the equation:
^{F}_{T}=F_{R}+F_{B}+F_{S+F}_{P}
F_{R}—force due to rubber hoop forces
F_{B}—force due to rubber beam deflection
F_{S}—force due to spring
F_{P}—force due to cavity pressure
   The subsidiary forces are calculated from the following equations (see the following for definitions):
   F_{R}=f(E, A, D_{S}, D_{L}, D_{C}, L_{C}&L)
   F_{B}=f(E, Dₗ, D_{S}, D_{L}, t & L)
   F_{S}=f (R_{R}, L &F)
   F_{P}=πC_{P} (Ds)(Dp)/C₂
   The force due to friction for each lip is calculated by the equation
   F_{f}=μF_{T}
   where μ is the coefficient of friction.

All three lips 30, 34 and 42 have separate flex points and dimensional values. The cross-sectional area (A) of a sealing lip is the entire area of the lip to the flex thickness (t). The flex point (Dₗ) is a point in the middle of the flex thickness. The center of gravity (D_{c}) is the center of gravity of the lip cross-sectional area (A). The shape factor coefficient (Dₚ) depends on the geometry of the lip and metal case.

### EXAMPLE

In a preferred embodiment of the present invention for use in a vehicle having a shaft diameter (D_{S}) of 46 mm, a cylinder diameter of 58 mm and a design internal hydraulic pressure of 170 lbs. per sq. in. (psi), the seal 10 was made of a low friction nitrile elastomer having durometer 80 hardness. The metal case or insert 20 was formed from one mm thick SAE 1008 carbon steel and the coil springs from SAE 30304 stainless steel. At rest prior to installation, the seal had the following dimensions:

| | | Inner | Outer |
|---|---|---|---|
| Dimension | Units | Lip (30) | Lip (34) |
| A - Cross sectional area | sq. inches | .0052 | .007 |
| C₁ - Constant 1 | lbs | 0.85 | 0.85 |
| C₂- Constant 2 | | 5092 | 5092 |
| D₁ - Diameter to center of | inches | 1.912 | 1.906 |
| flex point | | | |
| D_{C} - Diameter to center of gravity | inches | 1.888 | 1.920 |
| D_{L} - Lip internal diameter | inches | 1.785 | 1.772 |
| D_{P} - Shape Factor/Lip Geometry | | 3 | 2.58 |
| E - Modulus of elastomer | psi | 135 | 135 |
| F - Total spring tension | lbs. | na | 0.271 |
| L - Distance from flex point | inches | .079 | .081 |
| to lip contact point | | | |
| L_{c} - Distance from flex point | inches | .042 | .051 |
| to center of gravity | | | |
| Rᵣ - Distance from lip to center | inches | na | .023 |
| of spring | | | |
| t - Flex thickness | inches | .093 | .048 |
| θ - Lip angle | degrees | 20 | 20 |
| T_{F} - Total Force | lbs. | 7.05 | 6.90 |
| μ - Coefficient of Friction | | .18 | .18 |
| F_{f} - Friction Force | lbs | 1.269 | 1.242 |

The present seal design effectively balances oil side drag forces between the two oil seal lips 30 and 34, mitigates lip warp and grabbing, resists flattening of the lips and the beam 22, and assures a long seal service life.

The frictional forces between the oil side lips 30 and 34 will be substantially balanced under a varying cavity pressure range of 1 psi through 170 psi. It is recognized that the lip force loads will vary under different cavity pressures. The design is such that second lip 34 has the larger lip force through the pressure range. At 100 psi cavity pressure, second lip 34 will carry more lip force than first lip 30 and the drag forces between 32 and 34 will narrow to within 5%. When cavity pressure is 50 psi, lip 34 will carry more lip force than lip 30 and the drag forces between lips 30 and 34 will narrow to within 3%. It is preferred that at all cavity pressures levels that the lip 34 carry the greater lip force. At even lower pressure the balancing of load will greatly extend the seal's life under more normally vehicular applications. The low friction elastomers play a secondary role of providing smooth fork action without lip warp, stick slip or grabbing.

The objects and advantages of the invention have therefore been shown to be attained in a convenient, practical, economical and facile manner.

While a preferred embodiment of the invention has been herein illustrated and described, it is to be appreciated the various changes, rearrangements and modifications may be made therein without departing from the scope of the invention as defined by the appended claims.

Whereas, the present invention has been described in relation to the drawings attached hereto, it should be understood that other and further modifications, apart from those shown or suggested herein, may be made within the spirit and scope of this invention.

What is claimed is:

1. A seal for sealing between a pair of reciprocatory members, adapted to withstand a cavity pressure, comprising:
a sealing portion for sealing engagement with one of the members and a body portion for securement to the other of the members;
said body portion including an annular web for connecting to said sealing portion;
said sealing portion comprising an oil side beam extending in a direction generally parallel to the path of reciprocation of the members;
said oil side beam having a first sealing lip for engagement with the one member and a second sealing lip for engagement with the one member spaced from said first lip; and
said oil side beam having a narrowed neck between said first and sealing lips facilitating independent action of said lips, wherein said lips are correlated to balance with sliding friction between forces applied to the seal when subjected to the cavity pressure.

2. A seal as set forth in claim 1 wherein said one member is an inner cylindrical tube connected to a vehicle wheel and said other member is an outer cylindrical member connected to a vehicle body.

3. A seal as set forth in claim 1 wherein said sealing lips each have an interference fit with the one member.

4. A seal as set forth in claim 1 wherein said narrowed neck is proximate said first sealing lip.

5. A seal as set forth in claim 1 including a coil spring bearing on said oil side beam adjacent said second lip and biasing at least said second lip into engagement with the one member.

6. A seal as set forth in claim 5 wherein said beam, the narrowness of said neck, and the biasing force of said coil spring are correlated to balance between said lips forces applied to the seal to balance drag through out varying cavity pressure range.

7. A seal as set forth in claim 1 wherein said seal is fabricated from nitrile with a low friction rubber additive.

8. A seal as set forth in claim 1 including an air side beam extending in a direction opposite the oil side beam and generally parallel to the path of reciprocation of the members, said air beam having a sealing lip for sealing engagement with the one member at a location spaced from said first and second lips.

9. A seal for sealing between an inner shaft member and a co-axial outer cylinder member reciprocable relative to one another, said seal adapted to withstand a predetermined cavity pressure, said seal comprising:
an annular sealing portion for sealing engagement with said inner shaft member and an annular body portion for securement to the co-axial cylinder member;
said sealing portion comprising an annular oil side beam extending generally parallel to the path of reciprocation of the members;
said oil side beam being radially spaced from said body portion and defining an annular chamber therebetween;
said oil side beam having a first sealing lip for engagement with the one member and a second sealing lip for sealing engagement with the one member;
said beam having a narrowed neck between said lips; and
an annular coil spring on said beam adjacent said second sealing lip and biasing at least said second lip toward the one member, wherein said beam, said lips, said narrowed neck and said spring are correlated to adjust lip forces to balance drag forces exerted on said lips when the seal is subject to said predetermined cavity pressure.

10. A seal as set forth in claim 9 wherein said inner shaft member is connected to a vehicle wheel and said outer cylinder member is connected to a vehicle body.

11. A seal as set forth in claim 9 wherein said first and second sealing lips have an interference fit with the one member and the degrees of interference are included in the balancing correlation.

12. A seal as set forth in claim 9 including an air side beam extending in a direction opposite the oil side beam and generally parallel to the path of reciprocation of the members, said air side beam having at least a third sealing lip for sealing engagement with the one member at a location spaced from said first and second lips.
